(19) United States
(12) Patent Application Publication
(10) Pub. No.: US 2015/0027177 A1
(43) Pub. Date: Jan. 29, 2015

(54) LOCK FOR A MOTOR VEHICLE

(71) Applicant: Brose Schliesssysteme GmbH & Co. KG, Wuppertal (DE)

(72) Inventors: Dimitrii Kessler, Aachen (DE); Tomas Dreimann, Leverkusen (DE); Arkadi Bogorats, Haan (DE); Joerg Reinert, Remscheid (DE); Abdelali El-Hamoumi, Wuppertal (DE)

(73) Assignee: Brose Schliessysteme GmbH & Co., KG, Wuppertal (DE)

(21) Appl. No.: 14/381,500

(22) PCT Filed: Feb. 28, 2013
(86) PCT No.: PCT/EP2013/000585

§ 371 Date: Aug. 27, 2014

(30) Foreign Application Priority Data
Feb. 28, 2012 (DE) 10 2012 003 698.1

(51) Int. Cl. E05B 81/06

(52) U.S. Cl. CPC E05B 81/06
USPC 70/276

(57) ABSTRACT

A motor-vehicle lock with an adjusting element, which is adjustable about an adjusting element axis, and a drive for the adjustment of the adjusting element, the drive having a rotor, formed by the adjusting element, with a permanent magnet arrangement and a stator with a coil arrangement-comprising at least two coils, and the drive being designed in the manner of a direct drive. It is proposed that the stator has at least two poles, by way of which a magnetic field generated by the coil arrangement is made to pass, in that at least one pole of the stator reaches up to the rotor to within a gap which in cross section is essentially in the form of a segment of a ring, and in that the poles of the stator are magnetically coupled by way of a conducting arrangement running around the rotor with respect to the adjusting element axis.

### CROSS-REFERENCE TO RELATED APPLICATIONS

This application is a national stage application under 35 U.S.C. 371 of Inter-national Patent Application Serial No. PCT/EP2013/000585, entitled “Kraftfahrzeugschloss,” filed Feb. 28, 2013, which claims priority from German Patent Application No. DE 10 2012 003 698.1, filed Feb. 28, 2012, the disclosures of which are incorporated herein by reference.

### FIELD OF THE INVENTION

The invention relates to a motor-vehicle lock and to a method for activating such a motor-vehicle lock.

### BACKGROUND

The motor-vehicle lock in question is used in the case of all types of locking elements of a motor-vehicle. These include in particular side doors, rear doors, tailgates, rear opening hoods or engine hoods. These locking elements may in principle also be designed in the manner of sliding doors.

Modern motor-vehicle locks are provided with a whole series of functions that can be triggered in a motorized manner by means of electrical drives. In this respect, greatest possible compactness of the drives always presents a challenge.

The known motor-vehicle lock (DE 10 2008 012 563), on which the invention is based, has a drive for an adjustable functional element, which is designed in the manner of a direct drive. However, a disadvantage of the direct drive concerned is its low efficiency.

The invention addresses the problem of designing and developing the known motor-vehicle lock in such a way that the efficiency of the drive concerned is increased.

### SUMMARY

The above problem is solved in the case of a motor-vehicle lock as described herein.

The proposed motor-vehicle lock is provided with an adjusting element, which is adjustable about an adjusting element axis, and a drive for the adjustment of this adjusting element, the drive having a rotor, formed by the adjusting element, with a permanent magnet arrangement and a stator with a coil arrangement comprising at least two coils, and the drive being designed in the manner of a direct drive.

What is essential is the fundamental idea that the rotor and the stator can essentially interact by way of a magnetic field running radially with respect to the adjusting element axis. To be specific, the stator is provided with at least two poles, by way of which a magnetic field generated by the coil arrangement is made to pass. In this case, at least one pole of the stator reaches up to the rotor to within a gap which in cross section is essentially in the form of a segment of a ring, the poles of the stator being magnetically coupled by way of a conducting arrangement running around the rotor with respect to the adjusting element axis. In this respect, the gap in the form of a segment of a ring is aligned concentrically in relation to the adjusting element axis.

The proposed structural setup leads to high efficiency, in particular as a result of the reduction of air gaps in the magnetic circuit. By being designed as a direct drive, the drive is made up of few individual parts, so that not only are material costs reduced but also wear.

In an embodiment, the adjusting element is provided as a control shaft, in one variant the permanent magnet arrangement of the rotor that is formed by the control shaft being accommodated in or on a core cross section of the control shaft. The proposed structural setup of the drive with the resultant high efficiency makes it possible for the permanent magnet arrangement to be accommodated as above in or on the core cross section of the control shaft in spite of the comparatively unfavorable torque conditions prevailing there.

In an embodiment, the control shaft serves for setting the functional states “locked”, “unlocked”, “theft-protected”, “childproof-locked” and “childproof-unlocked”. The adjustment of the control shaft by means of the direct drive is particularly advantageous to the extent that the various functional states can be assumed largely at will, and in particular from functional states that are largely determined at will.

The aforementioned functional states of the motor-vehicle lock concern the possibility of opening a motor-vehicle door or the like by means of an interior door handle and by means of an exterior door handle. In the functional state “locked”, opening can be performed from the inside, but not from the outside. In the functional state “unlocked”, opening can be performed both from the inside and from the outside. In the functional state “theft-protected”, opening cannot be performed from either the inside or the outside. In the functional state “childproof-locked”, unlocking can be performed from the inside, but opening cannot be performed from either the inside or the outside. In the functional state “childproof-unlocked”, opening can be performed from the outside, but not from the inside.

In an embodiment, the functional element determining the respective functional state of the vehicle lock is designed as a wire or strip, which in one variant can be bent into different functional positions. With such a functional element designed as a wire or strip, the flexibility with regard to the setting at will of functional states can be fully exploited.

In an embodiment, H-bridge circuits, which have proven successful in the area of DC motors, are used for the activation of the coil arrangement.

An interesting aspect of an embodiment is the fact that a steady-state energization of the coil arrangement can lead to magnetically stable drive positions of the adjusting element. The formulation “magnetically stable” means here that the energization of the coil arrangement with the resultant magnetic field ensures that, when it is deflected out of the respective drive position, the adjusting element is always driven back into this drive position. The term “steady-state energization” means here that the energization that is set does not change in the time domain. The term “energization” should be understood here in the general sense and comprises both the application of an electrical voltage and the injection of an electrical current into the coil arrangement. In this respect, the voltage or the current may also be pulsed or the like. In the simplest case, for steady-state energization in the above sense, a constant voltage is applied to the relevant part of the coil arrangement.

In principle, the adjusting element may be of a one-part or multi-part design. In an embodiment, the adjusting element is of a multi-part design and in one variant has a shaft portion that is aligned with the adjusting element axis and is otherwise coupled, in particular connected, to the adjusting element. This is particularly advantageous in production engineering terms to the extent that the part of the adjusting element on the drive side can be produced and installed separately from the adjusting element. The coupling between the portions of the adjusting element may be provided in a form-fitting, force-closing or material-bonding manner. It is also conceivable for a releasable coupling to be used here.

In an embodiment, particularly flexible activation is obtained by the energization being performed by means of the logic unit of an electronic control device. The control device may be assigned to the motor-vehicle lock or to a number of motor-vehicle locks. It is also conceivable for the control device to be a component part of a central control device of the motor vehicle.

According to a further teaching, which is likewise of independent significance, a method for activating a proposed motor-vehicle lock is described herein.

What is essential according to this further teaching is the idea of differing steady-state energization of the coil arrangement for assuming at least two magnetically stable drive positions of the adjusting element. The associated advantages have already been explained further above.

The further proposed method is directed to the activation of a motor-vehicle lock that is in any case provided with an adjusting element, which is adjustable about an adjusting element axis, and a drive for the adjustment of the adjusting element, the drive having a rotor with a permanent magnet arrangement and a stator with a coil arrangement comprising at least two coils. The stator has at least two poles, by way of which a magnetic field generated by the coil arrangement is made to pass, at least one pole of the stator reaching up to the rotor to within a gap which in cross section is essentially in the form of a segment of a ring and the poles of the stator being magnetically coupled by way of a conducting arrangement running around the rotor with respect to the adjusting element axis.

An interesting aspect of the further method is that an electronic control device with a logic unit is provided, that the coil arrangement is energized in response to a signal from the logic unit and that, for assuming at least two magnetically stable drive positions, the coils of the coil arrangement are energized in response to a signal from the logic unit in a coil combination assigned to the respective drive position, in an energizing direction assigned to the respective drive position.

According to the further method, each drive position is therefore assigned a coil combination to be energized and an energizing direction. The term “energization of the coils in a coil combination” should be understood broadly here and comprises also the possibility of energizing a single coil of the coil arrangement. It is therefore of particular significance that, in response to a signal from the logic unit of the control device, a predetermined coil combination is energized in a predetermined energizing direction, so that the desired drive position is assumed.

The further method serves for activating a proposed motor-vehicle lock described above, the design of the drive as a direct drive being advantageous but not necessary. Otherwise, reference may be made to all of the statements made in relation to the proposed motor-vehicle lock.

In an embodiment, the invention provides a motor-vehicle lock with an adjusting element, which is adjustable about an adjusting element axis, and a drive for the adjustment of the adjusting element, the drive having a rotor, formed by the adjusting element, with a permanent magnet arrangement and a stator with a coil arrangement comprising at least two coils, and the drive being designed in the manner of a direct drive, wherein the stator has at least two poles, by way of which a magnetic field generated by the coil arrangement is made to pass, in that at least one pole of the stator reaches up to the rotor to within a gap which in cross section is essentially in the form of a segment of a ring, and in that the poles of the stator are magnetically coupled by way of a conducting arrangement running around the rotor with respect to the adjusting element axis.

In an embodiment, the permanent magnet arrangement is magnetized diametrically with respect to the adjusting element axis.

In an embodiment, the conducting arrangement comprises at least one stator lamination aligned perpendicularly in relation to the adjusting element axis. In an embodiment the conducting arrangement comprises a number of stator laminations, lying next to one another and assembled to form a stator core. In an embodiment, the conducting arrangement, in particular the at least one stator lamination, consists of a steel material, in particular of the steel material S235JR.

In an embodiment, the adjusting element is designed as a control shaft with at least one axial control portion for the execution of control movements, such as the control shaft has a core cross section, on which control elements such as control cams or the like are arranged, and in that the permanent magnet arrangement is accommodated in or on the core cross section of the control shaft.

In an embodiment, the motor-vehicle lock has a lock mechanism, which can be brought into various functional states such as “locked”, “unlocked”, “theft-protected”, “childproof-locked” and “childproof-unlocked”, at least one adjustable functional element being provided for setting the various functional states, the control shaft being in drive engagement or being able to be brought into drive engagement with the functional element or being a component part of the functional element. In an embodiment, the functional element is supported on a control portion of the control shaft.

In an embodiment, the control shaft can be brought by means of the drive into at least two control positions, in order to be able to set functional states such as “locked”, “unlocked”, “theft-protected”, “childproof-locked” and “childproof-unlocked”.

In an embodiment, the functional element is designed as a wire or strip and can be deflected into various functional positions. In an embodiment, the functional element is designed as a spring-elastic wire or strip, and thus, as a bending functional element, can be bent into various functional positions.

In an embodiment, a lever is provided, in particular an interior actuating lever or a locking lever, by the manual actuation of which a manual adjustment of the adjusting element about the adjusting element axis can be brought about.

In an embodiment, the coil arrangement has at least two, such as precisely two, pairs of coils, which are correspondingly activated in pairs. In an embodiment, in that the two coils are electrically connected in series.

In an embodiment, the two coils of a pair of coils are arranged diametrically oppositely with respect to the adjusting element axis. In an embodiment, two pairs of coils are arranged orthogonally in relation to one another.

In an embodiment, each pair of coils is assigned a driver circuit and in that the driver circuits are respectively designed as an H-bridge circuit, in that the H-bridge circuits respectively have two half-bridges, which are respectively coupled to one another by way of a bridge arm, and the respective pair of coils is connected into the respective bridge arm, such as the two H-bridge circuits of two pairs of coils share a common half-bridge.

In an embodiment, at least two magnetically stable drive positions of the adjusting element can be assumed by differing steady-state energization of the coil arrangement.

In an embodiment, at least one magnetically stable drive position of the adjusting element can be produced by the steady-state energization of a single pair of coils, and/or in that at least one magnetically stable drive position of the adjusting element can be produced by the simultaneous steady-state energization of two pairs of coils.

In an embodiment, the field vector of the magnetic field generated by the coil arrangement in the case of the simultaneous steady-state energization of two pairs of coils is aligned at a 45° angle to the field vector of the magnetic field generated by the coil arrangement in the case of the steady-state energization of a single pair of coils.

In an embodiment, depending on the respective adjusting path between two drive positions, the drive provides a differing drive torque, in that, depending on the respective adjusting path between two drive positions, a different mechanical counter-torque has to be overcome for the adjustment of the adjusting element, and in that the arrangement is set up in such a way that, with respect to at least two adjusting paths, the drive provides a higher drive torque in the case of the adjusting path with the higher counter-torque and provides a lower drive torque in the case of the adjusting path with the lower counter-torque.

In an embodiment, the adjusting element is of a multi-part design. In an embodiment, the adjusting element has a shaft portion that is aligned with the adjusting element axis and is otherwise coupled, in particular connected, to the adjusting element. In an embodiment, the adjusting element has at least two shaft portions that are aligned with the adjusting element axis and are coupled to one another, in particular connected to one another.

In an embodiment, an electronic control device with a logic unit is provided and in that the coil arrangement is able to undergo energization for assuming various drive positions by means of the logic unit of the electronic control device, and in that, for assuming each drive position, the logic unit of the control device activates an energization, such as steady-state energization, of the coil arrangement that is assigned to the respective drive position.

In an embodiment, when two pairs of coils are energized, all of the coils of these pairs of coils are always connected in series.

In an embodiment, the permanent magnet arrangement is arranged in a form-fitting manner on a rotor shaft and for this has at least one formation running along the rotor shaft, such as designed as a groove or as a bridge, such as the permanent magnet arrangement is designed as a hollow cylinder, and in that the formation runs along the inner side of the hollow cylinder, such as two formations are provided, arranged oppositely with respect to the rotor shaft.

In an embodiment, the coil arrangement undergoes differing steady-state energization for assuming at least two magnetically stable drive positions of the adjusting element.

In an embodiment, the coil arrangement has at least two, such as precisely two, pairs of coils, which are correspondingly activated in pairs, and in that at least one magnetically stable drive position of the adjusting element is produced by the steady-state energization of a single pair of coils.

In an embodiment, the coil arrangement has at least two, such as precisely two, pairs of coils, which are correspondingly activated in pairs, and in that at least one magnetically stable drive position of the adjusting element is produced by the simultaneous steady-state energization of two pairs of coils.

In an embodiment, the coil arrangement undergoes steady-state energization by means of the logic unit of an electronic control device for assuming various drive positions, and in that, for assuming each drive position, the logic unit of the control device activates a steady-state energization that is assigned to the respective drive position.

In an embodiment, the magnetic field of the permanent magnet arrangement is sensed by means of a sensor device and in that the operating state, in particular the position, of the rotor is determined from the measured sensor values of the sensor device, such as the sensor device comprises a Hall sensor.

In an embodiment, the voltage induced in the coil arrangement by the relative movement between the permanent magnet arrangement and the coil arrangement is measured by means of a measuring device, such as the operating state, in particular the position of the rotor, is determined from the measured values.

In an embodiment, the invention provides a method for activating a motor-vehicle lock, in particular a motor-vehicle lock as described herein, the motor-vehicle lock being provided with an adjusting element, which is adjustable about an adjusting element axis, and a drive for the adjustment of the adjusting element, the drive having a rotor with a permanent magnet arrangement and a stator with a coil arrangement comprising at least two coils, wherein the stator has at least two poles, by way of which a magnetic field generated by the coil arrangement is made to pass, in that at least one pole of the stator reaches up to the rotor to within a gap which in cross section is essentially in the form of a segment of a ring, and in that the poles of the stator are magnetically coupled by way of a conducting arrangement running around the rotor with respect to the adjusting element axis, in that an electronic control device with a logic unit is provided, in that the coil arrangement is energized in response to a signal from the logic unit and in that, for assuming at least two magnetically stable drive positions, the coils of the coil arrangement are energized in response to a signal from the logic unit in a coil combination assigned to the respective drive position, in an energizing direction assigned to the respective drive position.

In an embodiment, for assuming at least two magnetically stable drive positions, the coils of the coil arrangement are energized in response to the signal from the logic unit of an electronic control device for a predetermined energizing time, such as the energizing time is less than 500 ms, or such as less than 100 ms.

### BRIEF DESCRIPTION OF THE FIGURES

The invention is explained in more detail below on the basis of a drawing, which merely represents an exemplary embodiment and in which

FIG. 1 shows the component parts of a proposed motor-vehicle lock that are essential to the invention,

FIG. 2 shows the drive of the motor-vehicle lock according to FIG. 1 along the sectional line II-II,

FIG. 3 shows a state diagram for the drive according to FIG. 2,

FIG. 4 shows a driver circuit for the drive according to FIG. 2,

FIG. 5 shows an interconnection of the coils of the coil arrangement and

FIG. 6 shows a design of the rotor shaft and the permanent magnet arrangement.

### DETAILED DESCRIPTION

It may be pointed out in advance that only the components of the proposed motor-vehicle lock that are necessary for explaining the teaching are represented in the drawing. Correspondingly, a catch, which interacts in the customary way with a striker pin or the like and is held in a main closing position and in a possibly provided pre-closing position by means of a stop pawl, are not represented in the drawing.

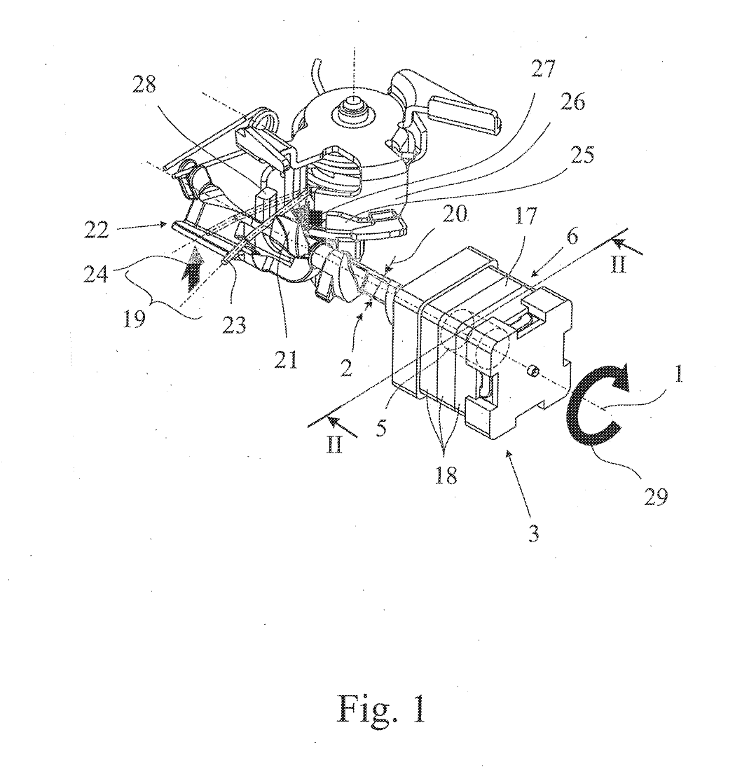

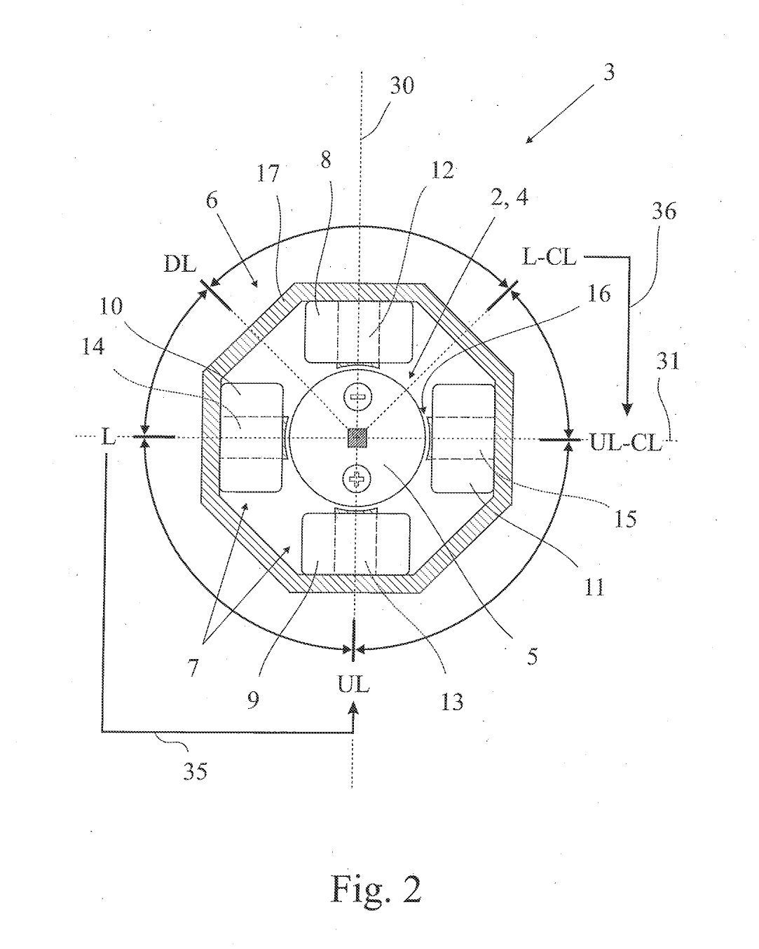

The motor-vehicle lock has an adjusting element 2, which is adjustable about an adjusting element axis 1, and a drive 3 for the adjustment of the adjusting element 2. The drive 3 serves for setting various functional states of the motor-vehicle lock, which is explained in detail further below. What is essential for the proposed teaching is firstly the basic structural setup comprising the adjusting element 2 and the drive 3. Joint consideration of FIGS. 1 and 2 shows that the drive 3 has a rotor, formed by the adjusting element 2, with an essentially cylindrical permanent magnet arrangement 5 and a stator 6 with a coil arrangement 7 comprising at least two coils 8-11, here altogether four coils 8-11. The fact that the adjusting element 2 is an integral component part of the drive 3 in the way described above, to be specific the rotor 4 of the drive 3, means that the drive 3 is designed in the manner of a direct drive. A transmission of some kind or other of the drive force or the drive torque through an interposed gear mechanism or the like is not required at this point.

The structural setup of the drive 3 that is represented in FIG. 2 is thus of interest. The stator 6 has at least two poles 12-15, here altogether four poles 12-15, by way of which a magnetic field generated by the coil arrangement 7 can be made to pass. In the case of the exemplary embodiment that is represented, the poles 12-15 of the stator 6 are respectively surrounded by a coil 8-11. In this case, the coils 8-11 can be designed as self-supporting coils, which are fitted onto the poles 12-15 of the stator 6. Such self-supporting coils are wound onto a coil core made of plastic or the like, so that they can be easily fitted onto the corresponding pole 12-15 of the stator 6.

In the case of the exemplary embodiment represented, all of the poles 12-15 of the stator 6 reach up to the rotor 4 to within a gap 16 which in cross section is essentially in the form of a segment of a ring. The cross section is a cross section perpendicular in relation to the adjusting element axis 1. The gap 16 essentially in the form of a segment of a ring runs concentrically in relation to the adjusting element axis 1, as can be taken from the representation according to FIG. 2.

The poles 12-15 of the stator 6 run radially with respect to the adjusting element axis 1 toward the rotor 4. They are magnetically coupled by way of a conducting arrangement 17 running around the rotor 4 with respect to the adjusting element axis 1. Seen in cross section perpendicularly in relation to the adjusting element axis 1, the conducting arrangement 17 here encloses the rotor 4 (FIG. 2).

With the drive 3 formed in the way explained above as a direct drive with a rotor 4 formed by the adjusting element 2, the gap 16 essentially in the form of a segment of a ring and the running-around conducting arrangement 17, a particularly low-loss overall arrangement can be achieved, in particular in that dispersion of the magnetic field is reduced to a minimum. The width of the annular gap 16 can be readily reduced to values below 0.5 mm.

It may be pointed out that the gap 16 essentially in the form of a segment of a ring does not have to be ideally in the form of a segment of a ring. It is also conceivable for the width of the gap 16 in the form of a segment of a ring to change over its course.

For the nature of the permanent magnet arrangement 5, a series of advantageous implementation possibilities are conceivable in principle. Here the permanent magnet arrangement 5 is magnetized diametrically with respect to the adjusting element axis 1, as can be taken from the representation according to FIG. 2.

The conducting arrangement 17 is designed such that it ensures a closed magnetic circuit between the poles 12-15 of the stator 6. For this, it is provided that the conducting arrangement 17 comprises at least one stator lamination 18 aligned perpendicularly in relation to the adjusting element axis 1. Joint consideration of FIGS. 1 and 2 shows that a number of stator laminations 18 are provided, lying next to one another and assembled to form a stator core. One of the areas in which the practice of implementing a number of stator laminations 18 lying next to one another is used is that of commutated DC motors, in order to reduce the eddy current losses that are produced as a result of high commutating frequencies. For this, the stator laminations 18 are often of a particularly thin form. Since high switching frequencies do not occur in the case of the proposed drive 3, the risk of eddy currents is low, so that the stator laminations 18 can be of a correspondingly thick design. In principle, the thickness of the stator laminations 18 may be of the same order of magnitude as the width of the coils 8-11. To this extent, the term “lamination” can be interpreted broadly. It is even conceivable for the entire conducting arrangement 17 to consist of a one-part, magnetically conductive material.

In a particularly low-cost design, the conducting arrangement 17, in particular the at least one stator lamination 18, is made of a steel material, in particular of the steel material S235JR. Other materials are conceivable.

An interesting aspect of the exemplary embodiment represented in FIG. 1 is the fact that the adjusting element 2 is designed as a control shaft with at least one axial control portion 19 for the execution of control movements. It has been recognized here that such a control shaft 2 can be used in a particularly advantageous way as a component part of a direct drive 3. The control shaft 2 has a core cross section 20, which extends over the entire control shaft 2 and on which control elements 21 such as control cams or the like are arranged. The permanent magnet arrangement 5 is accommodated here and optionally on the core cross section 20 of the control shaft 2. In principle, it is also conceivable for the permanent magnet arrangement 5 to be accommodated in the core cross section 20 of the control shaft 2.

In an embodiment, the permanent magnet arrangement 5 has at least one hard-ferrite magnet and/or at least one rare-earth magnet and/or at least one plastic-bonded magnet. Furthermore, with appropriate design, the adjusting element 2, in particular the control shaft 2, may also itself be magnetized and correspondingly form the permanent magnet arrangement 5. This is possible for example if the adjusting element 2 consists in any case partially or completely of an aforementioned material, in particular of a magnetizable plastics material.

In the case of the exemplary embodiment that is represented, the drive 3 serves for setting various functional states of the motor-vehicle lock. For this, the motor-vehicle lock has firstly a lock mechanism 22, which can be brought into various functional states such as “locked”, “unlocked”, “theft-protected”, “childproof-locked” and “childproof-unlocked”. These functional states are also referred to as “lock” or “L”, “unlock” or “UL”, “double lock” or “DL”, “lock-child lock” or “L-CL” and “unlock-child lock” or “UL-CL”. The meaning of these functional states for the possibility of opening the motor vehicle door or the like from the inside and from the outside have been explained in the general part of the description.

Here one adjustable functional element 23 is provided for setting the various functional states, the control shaft 2 being in drive engagement or being able to be brought into drive engagement with the functional element 23. It is also conceivable for the control shaft 2 itself to be a component part of the functional element 23.

Here the functional element 23 is supported on the control portion 19 of the control shaft 2. Depending on the position of the control shaft 2, the functional element 23 adjusts itself essentially perpendicularly in relation to the adjusting element axis 1, as is represented in FIG. 1 by the movement arrow 24 and by the representation of the functional element 23 by dashed lines.

The control shaft 2 can thus be brought by means of the drive 3 into at least two control positions, or into altogether five control positions, in order to be able to set the functional states of the motor-vehicle lock, here the functional states “locked”, “unlocked”, “theft-protected”, “childproof-locked” and “childproof-unlocked”.

The setup of the motor-vehicle lock is made particularly simple in the case of the exemplary embodiment that is represented by the functional element 23 being designed as a wire and being able to be deflected into various functional positions along the movement arrow 24. In principle, it is also conceivable for the functional element 23 to be designed as a strip. Here it is also the case that the functional element 23 is designed as a spring-elastic wire or strip, and thus, as a bending functional element, can be bent into the various functional positions.

The functional mode of the motor-vehicle lock in the functional states “unlocked” and “childproof-unlocked” are explained below. For an explanation of the basic functional mode of the motor-vehicle lock with the spring-elastic functional element 23, reference may otherwise be made to the international patent application WO 2009/040074 A1, to which the applicant reverts and the content of which is to this extent made the subject matter of the present application.

In the functional state “unlocked”, the functional element 23 is in its position that is at the bottom in FIG. 1 and is represented by a solid line. Consequently, the functional element 23 is in the range of movement of an interior actuating lever 25, which is coupled to an interior door handle, and in the range of movement of an exterior actuating lever 26, which is coupled to an exterior door handle. An adjustment of the interior actuating lever 25 or of the exterior actuating lever 26 in the direction of the movement arrow 27 has the effect that the functional element 23 follows the movement of the respective lever 25, 26 perpendicularly in relation to the extent of said element, comes up against the stop pawl 28, which is only indicated in FIG. 1, and in turn takes it along in the direction of the movement arrow 27 and lifts it out.

An adjustment of the control shaft 2 in the direction of the movement arrow 29 by 90° from the position represented in FIG. 1 leads to the setting of the functional state “childproof-unlocked”. In this state, the functional element 23 is in the position that is represented in FIG. 1 by a dashed line. An adjustment of the interior actuating lever 25 in the direction of the movement arrow 27 consequently has no effect on the functional element 23 and the stop pawl 28. The functional element 23 is however still located in the range of movement of the exterior actuating lever 26, so that lifting out of the stop pawl 28, and consequently opening of the motor-vehicle door, is possible by way of the exterior actuating lever 26, and consequently by way of the exterior door handle.

By analogy with the setting of the functional states “unlocked” and “childproof-unlocked” described above, all of the other functional states referred to above can also be implemented just by a corresponding adjustment of the control lever 2. The drive 3 is designed for correspondingly assuming all of the functional states, as still to be explained.

It has already been pointed out that designing the drive 3 as a direct drive makes it possible to dispense with gear components of any kind. For this reason, the drive 3 is mechanically designed as not self-locking, which makes unproblematic manual setting of functional states possible. In an embodiment, a manual adjustment of the adjusting element 2, here the control shaft 2, about the adjusting element axis 1 can be brought about by a manual actuation of a lever, such as an interior actuating lever 25 described above. Such a manual adjustment is provided in the functional state “locked”, in that actuation of the interior actuating lever 25 brings about an adjustment into the functional state “unlocked”, and in the functional state “childproof-locked”, in that actuation of the interior actuating lever 25 brings about an adjustment into the functional state “childproof-unlocked”.

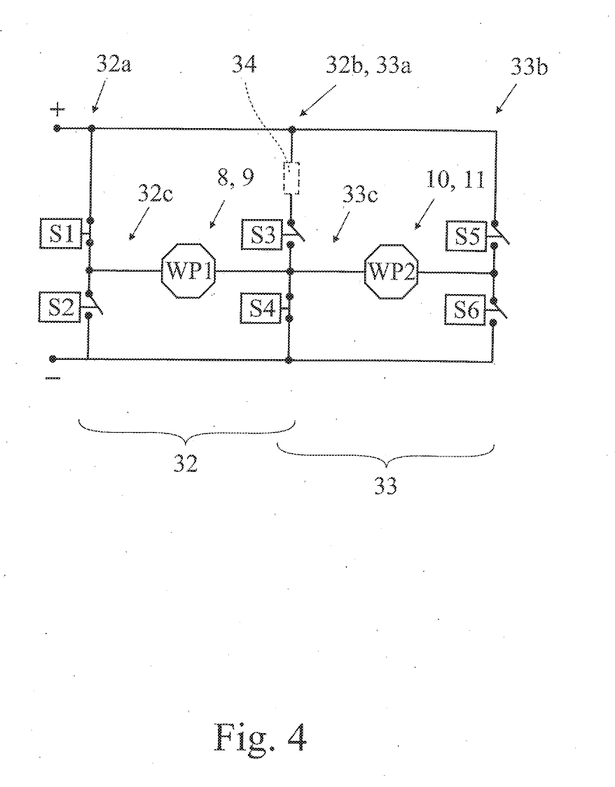

The design of the coil arrangement 7, in particular the design and arrangement of the coils 8-11, is of most particular significance in the present case. In an embodiment, the coil arrangement 7 has at least two, here precisely two, pairs of coils 8, 9; 10, 11, which are correspondingly activated in pairs. Here the two coils 8, 9; 10, 11 of a pair of coils are electrically connected in series and form in pairs the two winding assemblies WP1, WP2 (FIG. 4).

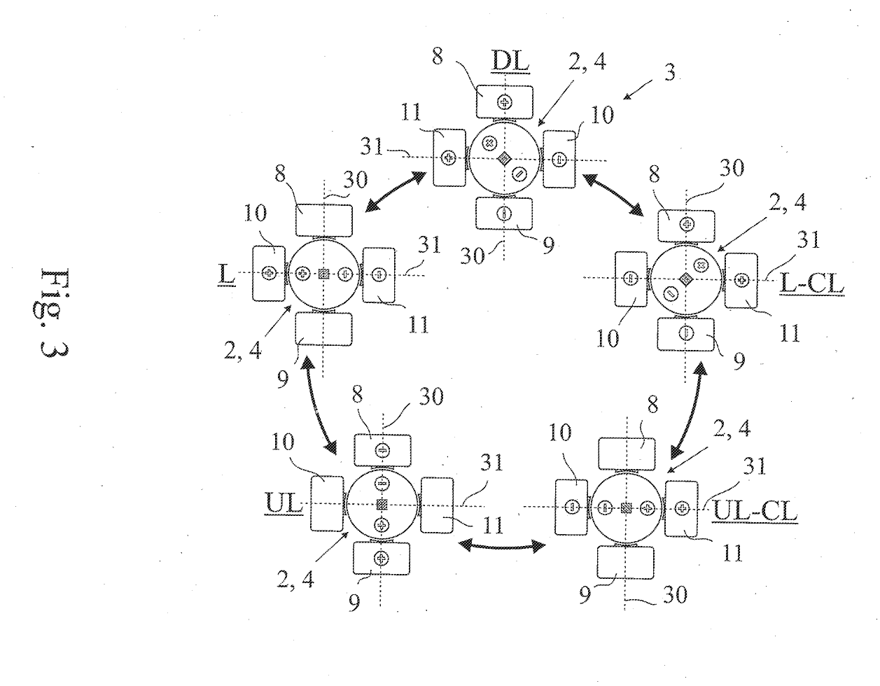

For the motor-vehicle lock represented, an arrangement of the coils 8-11 that is symmetrical with respect to the adjusting element axis 1 has proven successful. Correspondingly, the two coils 8, 9; 10, 11 of a pair of coils are arranged diametrically oppositely with respect to the adjusting element axis 1, the coil axes 30, 31 of the two opposing coils 8, 9; 10, 11 being aligned with one another and consequently being identical. This allows a largely homogeneous magnetic field to be generated, the coils 8, 9; 10, 11 representing as it were the magnetic poles assigned to this magnetic field. This can be taken from the representation according to FIG. 3, the magnetic poles respectively being indicated as “positive” and “negative”.

Joint consideration of FIGS. 2 and 3 shows that the two pairs of coils 8, 9; 10, 11 are arranged orthogonally in relation to one another. This means that the pairs of identical coil axes 30, 31 are aligned perpendicularly in relation to one another.

It may be pointed out that an aforementioned orthogonal alignment does not necessarily have to be provided. It may rather be the case that the common coil axes 30, 31 form an angle other than 90°. It may even be advantageous that the individual coils 8-11 are not arranged diametrically oppositely and are arranged unevenly around the adjusting element axis 1. The coil arrangement 7 can thus be adapted individually to the respective structural boundary conditions.

The energization still to be explained of the coil arrangement 7 can be implemented in a particularly simple way by each pair of coils 8, 9; 10, 11, that is to say each winding assembly WP1, WP2, being assigned a driver circuit 32, 33, as represented in FIG. 4. The driver circuits 32, 33 can be designed as an H-bridge circuit, the H-bridge circuits 32, 33 respectively having two half-bridges 32a, 32b, 33a, 33b, which are respectively coupled to one another by way of a bridge arm 32c, 33c, the respective pair of coils 8, 9; 10, 11, that is to say the respective winding assembly WP1, WP2, being connected into the respective bridge arm 32c, 33c. For the purpose of a particularly compact circuit arrangement, it is provided here that the two H-bridge circuits 32, 33 of two pairs of coils 8, 9; 10, 11 share a common half-bridge 32b, 33a. With the use of H-bridge circuits 32, 33 for the energization of the pair of coils 8, 9; 10, 11, particularly flexible energization is possible in a simple way. The switches S1-S6 are often designed as semiconductor switches. Corresponding bridge modules are available as integrated semiconductor components.

It already follows from the foregoing explanations that the proposed drive 3 is not primarily designed as a rotary drive that performs a multiplicity of revolutions for the adjustment of the adjusting element 2. Rather, the drive 3 is a kind of stepping motor, which specifically assumes a predetermined number of positions. It may be provided in this respect that the drive 3 does not perform more than one revolution. However, it is also conceivable that the drive 3 is designed as freely rotating in such a way that it can perform any number of revolutions step by step.

An interesting aspect of the proposed drive 3 is particularly the fact that at least two, here altogether five, magnetically stable drive positions of the adjusting element 2 can be assumed by differing steady-state energization of the coil arrangement 7.

In the sense of the aforementioned interpretation of the term “steady-state energization”, the energization is only switched on, and not for instance controlled with respect to a certain movement sequence or the like. It has already been explained above that the term “magnetically stable drive position” means in the present case that during the energization the adjusting element 2 is always urged into the corresponding drive position. This means that the drive positions that correspond to the corresponding control positions of the adjusting element 2 can be assumed without the necessity of an end stop or the like. This reduces wear and noise and simplifies the mechanical construction.

In the case of the exemplary embodiment that is represented, two different energizing variants are provided, depending on the desired drive position. In this case, at least one magnetically stable drive position of the adjusting element 2 can be produced by the steady-state energization of a single pair of coils 8, 9; 10, 11. This is the case according to FIG. 3 for the functional states “locked”, “unlocked” and “childproof-unlocked”.

In the case of at least one further magnetically stable drive position of the adjusting element 2, the simultaneous steady-state energization of two pairs of coils 8, 9; 10, 11 is provided. This is the case in FIG. 3 for the functional states “theft-protected” and “childproof-locked”.

It can be taken from the representation according to FIG. 3 that, in the case of the steady-state energization of a single pair of coils 8, 9; 10, 11, the magnetic field generated by the coil arrangement 7 is aligned with the common coil axis 30, 31 of the energized pair of coils 8, 9; 10, 11, while in the case of the simultaneous steady-state energization of two pairs of coils 8, 9; 10, 11 the magnetic field generated by the coil arrangement 7 is at a 45° angle to the coil axes 30, 31. It is correspondingly the case that the field vector of the magnetic field generated by the coil arrangement 7 in the case of the simultaneous steady-state energization of two pairs of coils 8, 9; 10, 11 is aligned at a 45° angle to the field vector of the magnetic field generated by the coil arrangement 7 in the case of the steady-state energization of a single pair of coils 8, 9; 10, 11.

An interesting aspect is thus that, depending on the respective adjusting path between two drive positions, the drive 3 provides a differing drive torque, in particular with the control circuit represented in FIG. 4. For example, more drive torque is available for the adjustment between two 90° positions represented in FIG. 3 than between a 90° position and a 45° position. This recognition can be used in the design of the motor-vehicle lock, so that the structural boundary conditions are adapted optimally to the behavior of the drive 3 when it is taken into account that, depending on the respective adjusting path between two drive positions, a different mechanical counter-torque has to be overcome for the adjustment of the adjusting element 2. It is specifically proposed to design the arrangement such that, with respect to at least two adjusting paths, the drive 3 provides a higher drive torque in the case of the adjusting path with the higher counter-torque and provides a lower drive torque in the case of the adjusting path with the lower counter-torque. This allows the achievement of an overall arrangement in which any overdimensioning of the drive 3 is reduced or eliminated.

There may be quite different reasons for the aforementioned counter-torque. It may be attributable to friction, latching springs, the spring-elastic functional element 23 or the like.

The functional mode of the drive 3 in the setting of the five functional states of the motor-vehicle lock described above is explained below on the basis of FIGS. 2 to 4.

The functional state “unlocked” can be achieved by the steady-state energization of the pair of coils 8, 9, in that exclusively the switches S1 and S4 in FIG. 4 are closed. The changeover into the functional state “locked” is performed by the steady-state energization of the pair of coils 10, 11 by closing exclusively the switches S4 and S5 in FIG. 4. The further changeover into the functional state “theft-protected” is performed by energizing both pairs of coils 8, 9; 10, 11, to be specific by closing exclusively the switches S5 and S2 in FIG. 4, whereby the two winding assemblies, that is to say the two pairs of coils 8, 9; 10, 11, are energized in series. The further changeover into the functional state “childproof-locked” is in turn performed by the steady-state energization of both pairs of coils 8, 9; 10, 11, the energizing of the pairs of coils 10, 11 being reversed in comparison with the last functional state, in that exclusively the switches S3, S2 and S6 in FIG. 4 are closed. In this state, the two winding assemblies WP1, WP2, that is to say the two pairs of coils 8, 9; 10, 11, are energized in parallel. The further changeover into the functional state “childproof-unlocked” is performed by the steady-state energization of the pair of coils 10, 11, in that exclusively the switches S3 and S6 in FIG. 4 are closed. Finally, the changeover into the initial state is performed by the energization of the pair of coils 8, 9, in that exclusively the switches S1 and S4 in FIG. 4 are closed.

From the aforementioned explanations there emerges the fact that, depending on the desired drive position, the pairs of coils 8, 9; 10, 11 are energized in series or in parallel. This can be implemented in a particularly simple way by the use of the proposed H-bridge circuits 32, 33. Since the electrical resistance of the pairs of coils 8, 9; 10, 11 energized in parallel is lower than the electrical resistance of the pairs of coils 8, 9; 10, 11 energized in series, it is proposed to connect a resistor 34 into the electrical supply line in the case of parallel energization. Such an electrical resistor 34, which can for example be enabled by way of an additional switch, is represented in FIG. 4 by a dashed line.

The fact that the diametrically magnetized permanent magnet arrangement 5 tries to follow the magnetic field generated by the coil arrangement 7 means that the direction of the magnetic field generated by the coil arrangement 7 corresponds essentially to the resultant direction of the rotor 4 carrying the permanent magnet arrangement 5. The angular position of the drive positions and the associated functional states of the motor-vehicle lock can be seen from joint consideration of FIGS. 2 and 3. It can be taken in particular from the representation according to FIG. 2 that a manual adjustment from the functional state “locked” into the functional state “unlocked” and from the functional state “childproof-locked” into the functional state “childproof-unlocked” is also possible, which is represented by the arrows 35, 36.

Depending on the design, it is possible that each of the drive positions represented in FIG. 3 can be assumed just by energizing the coil arrangement 7 in the way assigned to this drive position. However, it is also conceivable that, for reaching a desired drive position, at least one intermediate drive position has to be assumed. This is the case in particular if a minimal design of the coil arrangement 7 is provided in such a way that the drive torque is not sufficient for “skipping” an intermediate drive position. For example, it could be that, proceeding from the functional state “unlocked” into the functional state “theft-protected” in FIG. 3, the energizing of the coil arrangement 7 that is assigned to the functional state “theft-protected” is not sufficient to achieve the desired drive position. In such a case it is proposed to go from the functional state “unlocked” and initially assume the functional state “locked” and then assume the functional state “theft-protected”.

According to a further teaching, which is likewise of independent significance, the method explained above as such for activating a proposed motor-vehicle lock is claimed. What is essential about this method is that the coil arrangement 7 undergoes differing steady-state energization for assuming at least two magnetically stable drive positions of the adjusting element 2. Reference may be made to all of the aforementioned statements concerning the activation of the proposed motor-vehicle lock.

To sum up, it may be stated that with the proposed drive 3 it is possible to specifically assume predetermined drive positions, which respectively correspond to a functional state of the motor vehicle, without wear- and noise-intensive commutation being required. There is a high overall level of reliability, since no sliding contacts are necessary, the drive 3 is only made up of few individual parts and, on account of the stability of the drive positions, no end stops are required. The material costs are reduced as a result of the small number of components and in particular as a result of the fact that only a single drive is required for the setting of a multiplicity of functional states. This in turn is accompanied by a weight reduction in comparison with the known motor-vehicle locks.

It has also been found in tests that the actuating times in the setting of the functional states are short, since the actuating paths can be chosen to be short and since the inertia of the rotor 4 with the permanent magnet 5 is low in comparison with the inertia of the known rotors 4 of DC motors with copper coils.

Finally, the proposed drive 3 is advantageous with regard to a compact type of construction, since, as explained above, only a single drive is required for numerous functional states and since the design as a direct drive inevitably leads to low installation space requirements.

It may be pointed out that the proposed drive can be used in very different ways within the motor-vehicle lock. Apart from the setting of functional states, the drive 3 may for example be used for the motorized lifting out of the stop pawl 28, since only small actuating paths are required for this. In principle, however, use as part of a closing aid or the like is also conceivable.

It has already been pointed out in the general part of the description that the adjusting element 2 may be of a one-part or multi-part design. In an embodiment, the adjusting element 2 is of a multi-part design. For example, a control portion 19 referred to above may be designed as a separate part that is otherwise coupled, in particular connected, to the adjusting element 2. In an embodiment, it is the case that the adjusting element 2 has at least two shaft portions that are aligned with the adjusting element axis 1 and are coupled to one another, here and optionally connected to one another. The associated production engineering advantages have been explained in the general part of the description.

For the purpose of particularly flexible activation, an electronic control device with a logic unit is provided, the coil arrangement 7 being able to undergo energization by means of the logic unit of the electronic control device for assuming various drive positions. The logic unit can be of a programmable design. For example, the logic unit comprises a microprocessor, which is correspondingly programmable. Specifically, for assuming each drive position, the logic unit of the control device activates an energization of the coil arrangement that is assigned to the respective drive position.

In an embodiment, at least a part of the electronic control device is designed as a separate unit, such as with a housing of its own, which is otherwise electrically coupled to the motor-vehicle lock.

In the case of the exemplary embodiment represented in FIGS. 1 to 4, a proposed control device would activate the switches S1-S6 in a predetermined way. As explained further above, the control device may be assigned to a motor-vehicle lock or a number of motor-vehicle locks. It is also conceivable for the control device to be a component part of a higher-level control device of the motor vehicle.

The fact that the electronic control device can be of a programmable design means that logic operations can be set up almost at will and can be changed comparatively simply.

A further benefit of using an aforementioned control device is the possibility of controlling the energizing time by means of the control device, in particular to adapt it to the adjustment that is respectively planned. For example, it can be provided that the energization of the coil arrangement 7 is performed for a longer energizing time than is required for reaching the respective drive position. This is appropriate because it must be expected at relatively high adjusting speeds that the respective drive position of the adjusting element 2 is initially overshot and that “settling” in the respective drive position only takes place subsequently. To this extent, the control device controls the energizing time of the coil arrangement 7 in the adjustment of the adjusting element 2.

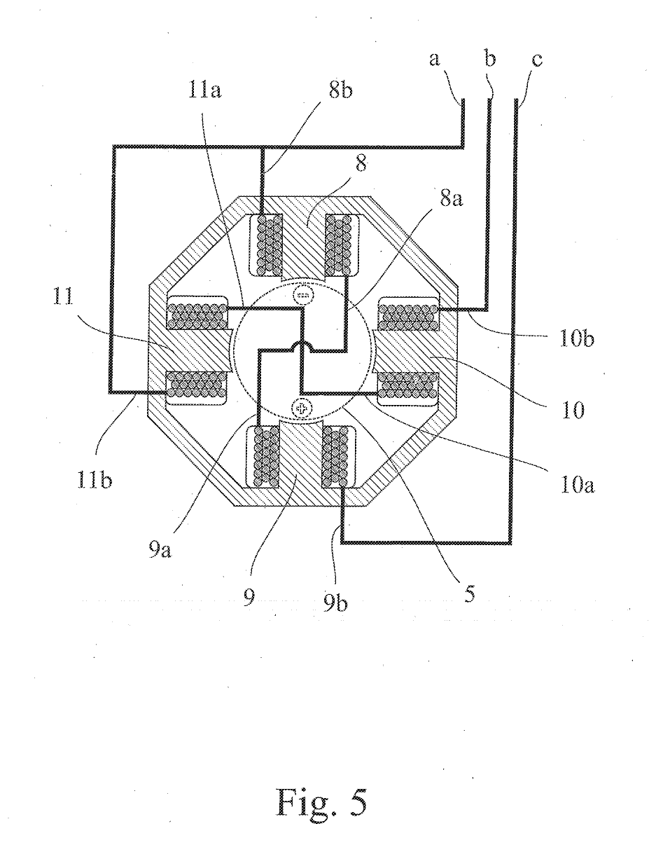

It has already been pointed out that the coils 8, 9, 10, 11 of the coil arrangement 7 can be energized in series and in parallel. With regard to the resultant level of the electrical current, a specific interconnection of the coil arrangement 7 that is represented in FIG. 5 has been found to be particularly advantageous. The associated driver circuit is not represented here. What is essential about the interconnection represented in FIG. 5 is the fact that, as explained further above, two pairs of coils 8, 9; 10, 11 are provided, the respective coils 8-10 of which are connected in series. This takes place by the interconnection of the coil terminals 8a and 9a and also the coil terminals 10a and 11a. Consequently, there are in principle four free coil terminals 8b, 9b, 10b, 11b available for energization. However, it is now proposed to connect the free coil terminal 8b of the coil 8 of the pair of coils 8, 9 to the free coil terminal 11b of a coil 11 of the pair of coils 10, 11. The coil arrangement 7 can thus be energized by way of the resultant free coil terminals 9b, 10b and also by way of the combined coil terminal 8b, 11b. It can be taken from the representation according to FIG. 5 that a parallel connection of the coils 8, 9, 10, 11 by way of the terminals a, b, c is ruled out. An interesting aspect of the interconnection of the coil arrangement 7 that is shown in FIG. 5 is the fact that only three terminals, to be specific the terminals a, b, c, are required for the aforementioned energization of the coil arrangement 7.

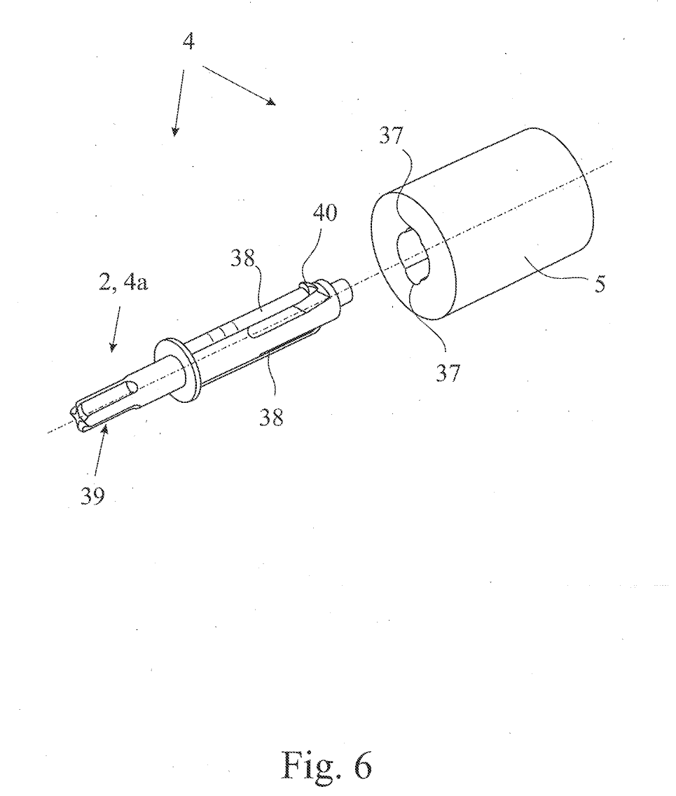

In view of the comparatively high accuracy requirements when assuming the respective drive positions of the adjusting element 2, the installation of the permanent magnet arrangement 5 is of most particular significance. According to FIG. 6, it can be the case that the permanent magnet arrangement 5 is arranged in a form-fitting manner on a rotor shaft 4a of the rotor 4, which here is formed by a separate shaft portion of the control shaft 2. This form fit is provided with regard to turning of the permanent magnet arrangement 5 with respect to the rotor shaft 4a. To produce the form fit, such as at least one formation 37 is provided, here running along the rotor shaft 4a. In an embodiment, the formation 37 is a groove that is in form-fitting engagement with a corresponding ridge 38. However, the formation 37 may in principle also be a ridge that is in form-fitting engagement with a corresponding groove. In the case of the exemplary embodiment that is represented in FIG. 6, the permanent magnet arrangement 5 is designed as a hollow cylinder, the formation 37 running along the inner side of the hollow cylinder. In order to obtain here a geometrical arrangement that is as symmetrical as possible, here two formations 37 are provided, arranged oppositely with respect to the rotor shaft 4a.

It has been shown in tests that the formations 37 can lie in a plane that lies perpendicularly in relation to the magnetic separating plane of the permanent magnet arrangement 5. The separating plane separates the two poles of the permanent magnet arrangement, which here are magnetized diametrically. An interesting aspect of the exemplary embodiment represented in FIG. 6 is also the fact that the adjusting element 2 is designed here in any case as two parts and is otherwise connected to the adjusting element 2 by way of a coupling portion 39.

It can finally be taken from the representation according to FIG. 6 that the rotor shaft 4a is provided with a detent 40, which engages behind the permanent magnet arrangement 5 installed on the rotor shaft 4a, so that the permanent magnet arrangement 5 is secured against pulling off in the axial direction.

It has already been pointed out that numerous possibilities for the implementation of the permanent magnet arrangement 5 are provided. It is also conceivable for a magnetizable plastic shaft to be used as the rotor shaft 4a.

The proposed arrangement opens up new possibilities for monitoring the operating state, in particular the position of the rotor 4.

In an embodiment, it is provided that the magnetic field of the permanent magnet arrangement 5 is sensed by means of a sensor device that is not represented and that the operating state, here the position, of the rotor 4 is determined from the measured sensor values of the sensor device. The sensor device may for example be a Hall sensor, an MR sensor or the like.

A second embodiment consists in that the voltage induced in the coil arrangement 7 by the relative movement between the permanent magnet arrangement 5 and the coil arrangement 7 is measured by means of a measuring device and/or the operating state, here the position, of the rotor 4, is determined from the measured values.

The term “determination of the operating state of the rotor 4” should be understood broadly in the present case. It also comprises items of information which, for example together with the data of a separate sensor, for example a rotary sensor, make a plausibility check possible.

Finally, it may be pointed out that the drive 3 of the proposed motor-vehicle lock can be operated in the above sense by a steady-state energization that can be implemented in a simple manner. However, it is also conceivable in principle for other types of energization, in particular energization that is controlled with regard to a predetermined movement sequence or the like, such as with the inclusion of measured sensor values, to be used.

According to a further teaching, which is of independent significance, a method for activating a motor-vehicle lock, in particular an aforementioned proposed motor-vehicle lock, is claimed. The motor-vehicle lock to be activated is provided with an adjusting element 2, which is adjustable about an adjusting element axis 1, and a drive 3 for the adjustment of the adjusting element 2, the drive 3 having a rotor 4 with a permanent magnet arrangement 5 and a stator 6 with a coil arrangement 7 comprising at least two coils 8-11.

What is essential about the further teaching is that an electronic control device with a logic unit is provided, that the coil arrangement 7 is energized in response to a signal from the logic unit and that, for assuming at least two magnetically stable drive positions, the coils 8-11 of the coil arrangement 7 are energized in response to a signal from the logic unit in a coil combination assigned to the respective drive position, in an energizing direction assigned to the respective drive position. The motor-vehicle lock can include a motor-vehicle lock described above, the design of the drive 3 as a direct drive being advantageous but not necessary. To this extent, reference may be made to the above statements.

In an embodiment, as indicated further above, at least a part of the electronic control device is designed as a separate unit, such as with a housing of its own, which is otherwise electrically coupled to the motor-vehicle lock.

The control device can also serve for presetting the energizing times for the coils 8-11, as already indicated further above. Specifically, for assuming at least two magnetically stable drive positions, the coils 8-11 of the coil arrangement 7 are energized in response to the signal from the logic unit of an electronic control device for a predetermined energizing time, the energizing time can be less than 500 ms, or less than 100 ms.

Finally, it may be pointed out that, in a design, the proposed motor-vehicle lock is provided with a housing, which receives at least some of the components of the motor-vehicle lock, in any case the adjusting element and the drive, and is at least partially encapsulated. In principle, however, it is also conceivable that merely a carrier is provided for the individual components of the motor-vehicle lock.

1. A motor-vehicle lock with an adjusting element, which is adjustable about an adjusting element axis, and a drive for the adjustment of the adjusting element, the drive having a rotor, formed by the adjusting element, with a permanent magnet arrangement and a stator with a coil arrangement comprising at least two coils, and the drive being designed in the manner of a direct drive,
wherein the stator has at least two poles, by way of which a magnetic field generated by the coil arrangement is made to pass, in that at least one pole of the stator reaches up to the rotor to within a gap which in cross section is essentially in the form of a segment of a ring, and in that the poles of the stator are magnetically coupled by way of a conducting arrangement running around the rotor with respect to the adjusting element axis.

2. The motor-vehicle lock as claimed in claim 1, wherein the permanent magnet arrangement is magnetized diametrically with respect to the adjusting element axis.

3. The motor-vehicle lock as claimed in claim 1, wherein the conducting arrangement comprises at least one stator lamination aligned perpendicularly in relation to the adjusting element axis.

4. The motor-vehicle lock as claimed in claim 1, wherein the adjusting element is designed as a control shaft with at least one axial control portion for the execution of control movements, and in that the permanent magnet arrangement is accommodated in or on the core cross section of the control shaft.

5. The motor-vehicle lock as claimed in claim 1, wherein the motor-vehicle lock has a lock mechanism, which can be brought into various functional states such as “locked”, “unlocked”, “theft-protected”, “childproof-locked” and “childproof-unlocked”, at least one adjustable functional element being provided for setting the various functional states, the control shaft being in drive engagement or being able to be brought into drive engagement with the functional element or being a component part of the functional element.

6. The motor-vehicle lock as claimed in claim 4, wherein the control shaft can be brought by means of the drive into at least two control positions, in order to be able to set functional states such as “locked”, “unlocked”, “theft-protected”, “childproof-locked” and “childproof-unlocked”.

7. The motor-vehicle lock as claimed in claim 1, wherein the functional element is designed as a wire or strip and can be deflected into various functional positions.

8. The motor-vehicle lock as claimed in claim 1, wherein a lever is provided, in particular an interior actuating lever or a locking lever, by the manual actuation of which a manual adjustment of the adjusting element about the adjusting element axis can be brought about.

9. The motor-vehicle lock as claimed in claim 1, wherein the coil arrangement has at least two pairs of coils, which are correspondingly activated in pairs.

10. The motor-vehicle lock as claimed in claim 9, wherein the two coils of a pair of coils are arranged diametrically oppositely with respect to the adjusting element axis.

11. The motor-vehicle lock as claimed in claim 9, wherein each pair of coils is assigned a driver circuit and in that the driver circuits are respectively designed as an H-bridge circuit, in that the H-bridge circuits respectively have two half-bridges, which are respectively coupled to one another by way of a bridge arm, and the respective pair of coils is connected into the respective bridge arm.

12. The motor-vehicle lock as claimed in claim 1, wherein at least two magnetically stable drive positions of the adjusting element can be assumed by differing steady-state energization of the coil arrangement.

13. The motor-vehicle lock as claimed in claim 1, wherein at least one magnetically stable drive position of the adjusting element can be produced by the steady-state energization of a single pair of coils, and/or in that at least one magnetically stable drive position of the adjusting element can be produced by the simultaneous steady-state energization of two pairs of coils.

14. The motor-vehicle lock as claimed in claim 1, wherein the field vector of the magnetic field generated by the coil arrangement in the case of the simultaneous steady-state energization of two pairs of coils is aligned at a 45° angle to the field vector of the magnetic field generated by the coil arrangement in the case of the steady-state energization of a single pair of coils.

15. The motor-vehicle lock as claimed in claim 1, wherein, depending on the respective adjusting path between two drive positions, the drive provides a differing drive torque, in that, depending on the respective adjusting path between two drive positions, a different mechanical counter-torque has to be overcome for the adjustment of the adjusting element, and in that the arrangement is set up in such a way that, with respect to at least two adjusting paths, the drive provides a higher drive torque in the case of the adjusting path with the higher counter-torque and provides a lower drive torque in the case of the adjusting path with the lower counter-torque.

16. The motor-vehicle lock as claimed in claim 1, wherein the adjusting element is of a multi-part design.

17. The motor-vehicle lock as claimed in claim 1, wherein an electronic control device with a logic unit is provided and in that the coil arrangement is able to undergo energization for assuming various drive positions by means of the logic unit of the electronic control device, and in that, for assuming each drive position, the logic unit of the control device activates an energization.

18. The motor-vehicle lock as claimed in claim 1, wherein, when two pairs of coils are energized, all of the coils of these pairs of coils are always connected in series.

19. The motor-vehicle lock as claimed in claim 1, wherein the permanent magnet arrangement is arranged in a form-fitting manner on a rotor shaft and for this has at least one formation running along the rotor shaft.

20. A method for activating a motor-vehicle lock as claim 1, wherein the coil arrangement undergoes differing steady-state energization for assuming at least two magnetically stable drive positions of the adjusting element.

21. The method as claimed in claim 20, wherein the coil arrangement has at least two pairs of coils, which are correspondingly activated in pairs, and in that at least one magnetically stable drive position of the adjusting element is produced by the steady-state energization of a single pair of coils.

22. The method as claimed in claim 20, wherein the coil arrangement has at least two pairs of coils, which are correspondingly activated in pairs, and in that at least one magnetically stable drive position of the adjusting element is produced by the simultaneous steady-state energization of two pairs of coils.

23. The method as claimed in claim 20, wherein the coil arrangement undergoes steady-state energization by means of the logic unit of an electronic control device for assuming various drive positions, and in that, for assuming each drive position, the logic unit of the control device activates a steady-state energization that is assigned to the respective drive position.

24. The method as claimed in claim 20, wherein the magnetic field of the permanent magnet arrangement is sensed by means of a sensor device and in that the operating state, in particular the position, of the rotor is determined from the measured sensor values of the sensor device.

25. The method as claimed in claim 20, wherein the voltage induced in the coil arrangement by the relative movement between the permanent magnet arrangement and the coil arrangement is measured by means of a measuring device.

26. A method for activating a motor-vehicle lock, the motor-vehicle lock being provided with an adjusting element, which is adjustable about an adjusting element axis, and a drive for the adjustment of the adjusting element, the drive having a rotor with a permanent magnet arrangement and a stator with a coil arrangement comprising at least two coils,
wherein the stator has at least two poles, by way of which a magnetic field generated by the coil arrangement is made to pass, in that at least one pole of the stator reaches up to the rotor to within a gap which in cross section is essentially in the form of a segment of a ring, and in that the poles of the stator are magnetically coupled by way of a conducting arrangement running around the rotor with respect to the adjusting element axis, in that an electronic control device with a logic unit is provided, in that the coil arrangement is energized in response to a signal from the logic unit and in that, for assuming at least two magnetically stable drive positions, the coils of the coil arrangement are energized in response to a signal from the logic unit in a coil combination assigned to the respective drive position, in an energizing direction assigned to the respective drive position.

27. The method as claimed in claim 26, wherein, for assuming at least two magnetically stable drive positions, the coils of the coil arrangement are energized in response to the signal from the logic unit of an electronic control device for a predetermined energizing time.
